(19) United States
(12) Patent Application Publication
(10) Pub. No.: US 2020/0096819 A1
(43) Pub. Date: Mar. 26, 2020

(54) DISPLAY DEVICE

(71) Applicant: Shenzhen China Star Optoelectronics Semiconductor Display Technology Co., Ltd., Shenzhen, Guangdong (CN)

(72) Inventor: Yong FAN, Shenzhen, Guangdong (CN)

(21) Appl. No.: 16/329,242

(22) PCT Filed: Jan. 15, 2019
(86) PCT No.: PCT/CN2019/071768

§ 371 Date: Feb. 28, 2019

(30) Foreign Application Priority Data
Sep. 26, 2018 (CN) 201811126158.8

(51) Int. Cl. G02F 1/1335

(52) U.S. Cl. CPC G02F 1/133603; G02F 2001/133302; G02F 1/133605; G02F 1/133528

(57) ABSTRACT

The present invention provides a display device including a liquid crystal panel and a backlight module, wherein the liquid crystal panel includes a display area and a non-display area, the display area is provided with a plurality of pixel units, and the non-display area is a transparent area; the backlight module includes a back panel and a light source assembly disposed between the back panel and the liquid crystal panel, and the light source assembly includes sub-light sources corresponding to the pixel units in one-to-one correspondence.

### FIELD OF INVENTION

The present invention relates to the field of display technologies, and in particular, to a display device.

### BACKGROUND OF INVENTION

In a conventional transparent display LCD, a conventional direct-type or side-in backlight is used or directly uses a behind ambient light as a light source. In order to increase transparency of the liquid crystal panel, a proportion of the non-color area (transparent area) is higher, so that a luminance ratio of the color pixel area to the non-color area is lower so that contrast and color performance of the screen is worse.

### TECHNICAL PROBLEM

In the conventional transparent display LCD, the luminance ratio of the color pixel area to the non-color area is low, so that the contrast and color performance of the picture are poor.

### TECHNICAL SOLUTION

A display device, comprising: a liquid crystal panel including a display area and a non-display area, the display area is provided with a plurality of pixel units, the non-display area is a transparent area, the liquid crystal panel further including, disposed in order from bottom to top, a first polarizer, a first glass substrate disposed on the first polarizer, a second glass substrate, and a second polarizer disposed on the second glass substrate; and a backlight module including a back panel and a light source assembly disposed between the back panel and the liquid crystal panel, and the light source assembly including sub-light sources corresponding to the pixel units in one-to-one correspondence.

Preferably, the pixel units are arranged in an array.

Preferably, the pixel units are disposed in intervals.

Preferably, the back panel is transparent.

Preferably, all of the sub-light sources are disposed on the back panel such that the light emitted by the sub-light sources directly illuminates the liquid crystal panel.

Preferably, a plurality of cavities each are defined between two adjacent sub-light sources.

Preferably, the sub-light sources are scattered light sources.

Preferably, the back panel is a light reflecting panel, and a side of the back panel close to the sub-light source is provided with a light reflecting surface.

Preferably, a plurality of light shielding walls each are disposed between two adjacent sub-light sources

Preferably, the sub-light sources each comprise a light emitting chip and a phosphor layer disposed on the light emitting chip.

A display device, comprising: a liquid crystal panel including a display area and a non-display area, the display area is provided with a plurality of pixel units, the non-display area is a transparent area; the backlight module including a back panel and a light source assembly disposed between the back panel and the liquid crystal panel, and the light source assembly includes sub-light sources corresponding to the pixel units in one-to-one correspondence.

Preferably, the pixel units are arranged in an array.

Preferably, the pixel units are disposed in intervals.

Preferably, the back panel is transparent.

Preferably, all of the sub-light sources are disposed on the back panel such that the light emitted by the sub-light sources directly illuminates the liquid crystal panel.

Preferably, a plurality of cavities each are defined between two adjacent sub-light sources.

Preferably, the sub-light sources are scattered light sources.

Preferably, the back panel is a light reflecting panel, and a side of the back panel close to the sub-light source is provided with a light reflecting surface.

Preferably, a plurality of light shielding walls each are disposed between two adjacent sub-light sources.

Preferably, the sub-light sources each comprise a light emitting chip and a phosphor layer disposed on the light emitting chip.

### BENEFICIAL EFFECT

Each pixel unit has a corresponding sub-light source, and the brightness of the display area where the pixel unit is located is improved by the sub-light source, thereby improving the contrast and color performance of the screen such that the quality of the display device is improved.

### DESCRIPTION OF DRAWINGS

In order to more clearly illustrate the technical solutions in the embodiments of the present invention, the following figures described in the embodiments will be briefly introduced. It is obvious that the drawings described below are merely some embodiments of the present invention, other drawings can also be obtained by the person ordinary skilled in the field based on these drawings without doing any creative activity.

FIG. 1 is a schematic view showing the arrangement of pixel units in a preferred embodiment of the present invention;

FIG. 2 is a schematic structural diagram of a display device according to embodiment 1 of the present invention;

FIG. 3 is a schematic structural diagram of a display device according to embodiment 2 of the present invention.

Reference numerals: 10, liquid crystal panel; 11, display area; 111, pixel unit; 12, non-display area; 13, first polarizer; 14, first glass substrate; 15, second glass substrate; 16, second polarizer; 20, backlight module; 21, back panel; 22, sub-light source; 23, light shielding wall.

### DETAILED DESCRIPTION OF PREFERRED EMBODIMENTS

The technical solutions in the embodiments of the present invention will be clearly and completely described as follows with reference to the drawings in the embodiments of the present invention. Obviously, the described embodiments are a part of the embodiments in the invention, not all of them. Based on the embodiments of the present invention, all other embodiments obtained by those skilled in the field without doing any creative activity are within the claimed scope of the present invention.

In the description of the present invention, the terms “first” and “second” are used for descriptive purpose only and are not to be construed as indicating or implying a relative importance or implicitly indicating the number of the specified technical features. Thus, the features defining “first” or “second” may include one or more described features either explicitly or implicitly. In the description of the present invention, the meaning of “a plurality of” denotes two or more unless it is otherwise specifically stated.

### Embodiment 1

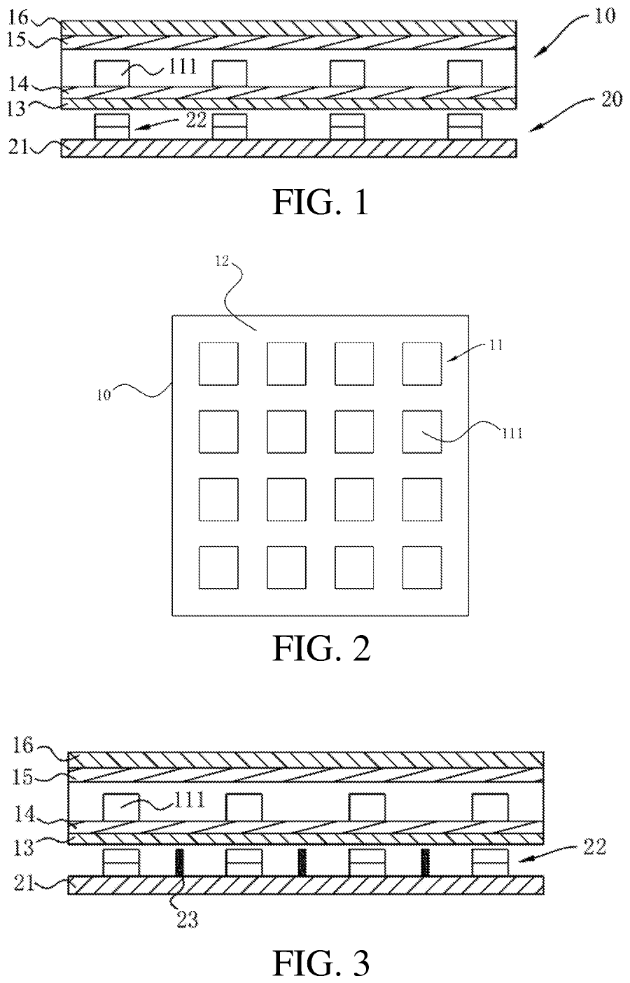

A display device, as shown in FIGS. 1 and 2, the display device comprises liquid crystal panel 10 and backlight module 20.

Wherein, the liquid crystal panel 10 further includes, disposed in order from bottom to top, a first polarizer 13, a first glass substrate 14 disposed on the first polarizer 13, a second glass substrate 15, and a second polarizer 16 disposed on the second glass substrate 15;

The liquid crystal panel 10 includes a display area 11 and a non-display area 12, the display area 11 is provided with a plurality of pixel units 111, the non-display area 12 is a transparent area.

Wherein, the backlight module 20 includes a back panel 21 and a light source assembly disposed between the back panel 21 and the liquid crystal panel 10, and the light source assembly includes sub-light sources 22 corresponding to the pixel units 111 in one-to-one correspondence.

Specifically, each pixel unit 111 has a corresponding sub-light source 22, and the brightness of the display area 11 where the pixel unit 111 is located is improved by the sub-light source 22, thereby improving the contrast and color performance of the screen and such that the quality of the display device is improved.

The pixel units 111 are uniformly arranged in an array. The color contrast of the display area 11 and the non-display area 12 is improved by the orderly uniform array arrangement of the pixel units 111.

The back panel 21 is a transparent back panel 21 to improve the transparency of the display device.

Specifically, all of the sub-light sources 22 are disposed on the back panel 21 such that the light emitted by the sub-light source 22 directly illuminates the liquid crystal panel 10 without passing through other light guiding film materials, the arrangement of components is reduced and thereby reducing the production cost. In addition, reducing the light loss during the process in which the light emitted from the sub-light source 22 is incident to the liquid crystal panel 10, the sub-light source 22 consumes less power and meet the requirement of brightness of the liquid crystal panel 10.

Further, a plurality of cavities each are defined between two adjacent sub-light sources 22 thereby the transparency of the display device is improved.

It can be understood that the sub-light source 22 can be a direct light source or a scattered light source.

When the sub-light source 22 uses a scattering light source, a portion of the light emitted by the sub-light source 22 passes through the back panel 21, thereby improving the transparency of the display device; when the sub-light source 22 uses a direct-type light source, it is convenient to adjust the amount of light incident to the pixel unit 111, thereby facilitating the adjustment of the brightness contrast of the display area 11 and the non-display area 12.

The sub-light source 22 includes a light emitting chip and a phosphor layer disposed on the light emitting chip.

### Embodiment 2

A display device, as shown in FIGS. 2 and 3, the display device comprises liquid crystal panel 10 and backlight module 20.

Wherein, the liquid crystal panel 10 further includes, disposed in order from bottom to top, a first polarizer 13, a first glass substrate 14 disposed on the first polarizer 13, a second glass substrate 15, and a second polarizer 16 disposed on the second glass substrate 15.

The liquid crystal panel 10 includes a display area 11 and a non-display area 12, the display area 11 is provided with a plurality of pixel units 111, the non-display area 12 is a transparent area.

Wherein, the backlight module 20 includes a back panel 21 and a light source assembly disposed between the back panel 21 and the liquid crystal panel 10, and the light source assembly includes sub-light sources 22 corresponding to the pixel units 111 in one-to-one correspondence.

Each pixel units 111 has a corresponding sub-light source 22, and the brightness of the display area 11 where the pixel unit 111 is located is increased by the sub-light source 22, thereby improving the contrast and color performance of the screen, and such that the quality of the display device is improved.

Specifically, the pixel units 111 are uniformly arranged in an array. The color contrast of the display area 11 and the non-display area 12 is improved by the orderly uniform array arrangement of the pixel units 111.

The pixel units 111 are disposed in intervals. The area of the non-display area 12 is enlarged, thereby improving transparency and the contrast of color and brightness of the display area 11 and the non-display area 12.

Wherein, the sub-light source 22 is a scattered light source. The sub-light source 22 is used to simultaneously provide light sources for the display area 11 and the non-display area 12, thereby reducing production costs.

The back panel 21 is made of a non-transparent material, the back panel 21 is a light reflecting panel, and a side of the back panel 21 close to the sub-light source 22 is provided with a light reflecting surface.

A portion of the light emitted by the sub-light source 22 is reflected to the non-display area 12 by the light reflecting surface, thereby increasing the transparency of the non-display area 12.

Specifically, a plurality of light shielding walls 23 each are disposed between two adjacent sub-light sources 22. The light emitted from the sub-light source 22 is prevented from interfering with each other on the pixel unit 111, thereby the overall display of the liquid crystal panel 10 is more uniform.

The sub-light sources 22 each comprise a light emitting chip and a phosphor layer disposed on the light emitting chip.

The beneficial effects of the present invention are: each pixel unit 111 has a corresponding sub-light source 22, and the brightness of the display area 11 where the pixel unit 111 is located is improved by the sub-light source 22, thereby improving the contrast and color performance of the screen, thereby improving the quality of display device.

The description of the above exemplary embodiments is only for the purpose of understanding the invention. It is to be understood that the present invention is not limited to the disclosed exemplary embodiments. It is obvious to those skilled in the art that the above exemplary embodiments may be modified without departing from the scope and spirit of the present invention.

What is claimed is:

1. A display device, comprising:
a liquid crystal panel including a display area and a non-display area, the display area provided with a plurality of pixel units, the non-display area being a transparent area, the liquid crystal panel further including, disposed in order from bottom to top, a first polarizer, a first glass substrate disposed on the first polarizer, a second glass substrate, and a second polarizer disposed on the second glass substrate; and
a backlight module including a back panel and a light source assembly disposed between the back panel and the liquid crystal panel, and the light source assembly including sub-light sources corresponding to the pixel units in one-to-one correspondence.

2. The display device according to claim 1, wherein the pixel units are arranged in an array.

3. The display device according to claim 1, wherein the pixel units are disposed in intervals.

4. The display device according to claim 3, wherein the back panel is transparent.

5. The display device according to claim 4, wherein all of the sub-light sources are disposed on the back panel such that the light emitted by the sub-light sources directly illuminates the liquid crystal panel.

6. The display device according to claim 3, wherein a plurality of cavities each are defined between two adjacent sub-light sources.

7. The display device according to claim 3, wherein the sub-light sources are scattered light sources.

8. The display device according to claim 7, wherein the back panel is a light reflecting panel, and a side of the back panel close to the sub-light source is provided with a light reflecting surface.

9. The display device according to claim 8, wherein a plurality of light shielding walls each are disposed between two adjacent sub-light sources.

10. The display device according to claim 1, wherein the sub-light sources each comprise a light emitting chip and a phosphor layer disposed on the light emitting chip.

11. A display device, comprising:
a liquid crystal panel including a display area and a non-display area, the display area being provided with a plurality of pixel units, the non-display area being a transparent area;
the backlight module including a back panel and a light source assembly disposed between the back panel and the liquid crystal panel, and the light source assembly includes sub-light sources corresponding to the pixel units in one-to-one correspondence.

12. The display device according to claim 11, wherein the pixel units are arranged in an array.

13. The display device according to claim 12, wherein the pixel units are disposed in intervals.

14. The display device according to claim 13, wherein the back panel is transparent.

15. The display device according to claim 14, wherein all of the sub-light sources are disposed on the back panel such that the light emitted by the sub-light sources directly illuminates the liquid crystal panel.

16. The display device according to claim 13, wherein a plurality of cavities each are defined between two adjacent sub-light sources.

17. The display device according to claim 13, wherein the sub-light sources are scattered light sources.

18. The display device according to claim 17, wherein the back panel is a light reflecting panel, and a side of the back panel close to the sub-light source is provided with a light reflecting surface.

19. The display device according to claim 18, wherein a plurality of light shielding walls each are disposed between two adjacent sub-light sources.

20. The display device according to claim 11, wherein the sub-light sources each comprise a light emitting chip and a phosphor layer disposed on the light emitting chip.
